(19) United States
(12) Patent Application Publication
(10) Pub. No.: US 2024/0079666 A1
(43) Pub. Date: Mar. 7, 2024

(54) A PROCESS FOR RECOVERING COBALT FROM LITHIUM-ION BATTERIES

(71) Applicant: NEWSOUTH INNOVATIONS PTY LIMITED, Sydney, NSW (AU)

(72) Inventors: Veena SAHAJWALLA, Sydney, NSW (AU); Rumana HOSSAIN, Sydney, NSW (AU)

(21) Appl. No.: 18/272,336

(22) PCT Filed: Jan. 14, 2022
(86) PCT No.: PCT/AU2022/050014

§ 371 Date: Jul. 13, 2023

(30) Foreign Application Priority Data
Jan. 15, 2021 (AU) 2021900078

(51) Int. Cl. H01M 10/54; C22B 1/02; C22B 5/10; C22B 23/02

(52) U.S. Cl. CPC H01M 10/54; C22B 1/02; C22B 5/10; C22B 23/021

(57) ABSTRACT

The present disclosure broadly relates to a process for recovering cobalt from lithium-ion batteries using thermal techniques.

### FIELD OF THE DISCLOSURE

The present disclosure broadly relates to a process for recovering cobalt from lithium-ion batteries using thermal techniques.

### BACKGROUND OF THE DISCLOSURE

Any discussion of the prior art throughout this specification should in no way be considered as an admission that such prior art is widely known or forms part of the common general knowledge in the field.

The proliferation of lithium-ion batteries (LIBs) in compact electronics—and more recently, electric automobiles—will lead to the generation of large quantities of spent batteries. It is estimated that over 11 million tonnes of spent LIBs will be discarded through to 2030, with under 5% of discarded LIBs recycled to date. Presently, the majority of spent LIBs are disposed of in landfill which is problematic due to the presence of hazardous materials in the LIBs.

LIBs contain numerous metallic resources including copper, aluminium, cobalt and lithium. The demand for cobalt increased from 65,000 to 90,000 tonnes/annum between 2010 and 2015. Demand for cobalt to manufacture batteries in the automotive sector is likely to increase by 500% in 2025. As such, the sustainable recovery of cobalt from the problematic waste source of LIBs has a vital role in both the economy and the environment.

Current efforts on recycling LIBs focus on hydrometallurgical processes. These processes utilize aqueous-chemistry-based extractive metallurgy to recover metals from the electrodes of spent LIBs. The disassembled electrodes are dispersed in a concentrated acidic solvent, followed by the separation of metallic ions from the dissolved solution by extraction, precipitation or electrodeposition. Such processes involve the consumption of a significant amount of organic elements and hazardous chemicals, and can potentially cause secondary pollution by generating large amounts of waste, including acid and alkaline solutions, ionic components of heavy metals, and liquid organic waste. A further problem with hydrometallurgical procedures involves the production of fluorine-containing wastewater due to inadequate removal of the electrolyte and binder materials. The resultant wastewater treatment required adds to the complexity and overall cost of the processes.

Pyrometallurgical techniques are also commonly used to devolatilise organic substances, along with the moisture content present in the waste binders and electrolytes of the LIBs. Valuable metallic content can then be recovered from the leftover residue after pyrolytic degradation. However, these processes use high temperatures and employ long processing times that make metal recovery highly impractical.

While a range of recycling methods for the recovery of useful metals from spent LIBs have been proposed, the environmental and economic impacts of these methods are unsatisfactory. There is therefore a need for improved processes for recovering metals from LIBs.

The present inventors have developed an efficient process to recover cobalt from LIBs that is based on thermal techniques.

### SUMMARY OF THE DISCLOSURE

In a first aspect there is provided a process for recovering cobalt from LIBs, the process comprising:
(a) heating: (i) cathodes obtained from the LIBs, the cathodes comprising a first metal foil and a cobalt-containing compound, and (ii) anodes obtained from the LIBs, the anodes comprising a second metal foil and carbon, so as to provide first and second metal foils, a thermal cathode product comprising the cobalt-containing compound, and a thermal anode product comprising the carbon; and
(b) heating a mixture of the thermal cathode product and the thermal anode product for a period of time sufficient to produce the cobalt.

The LIBs may be waste or spent LIBs.

The carbon may be graphite.

Step (a) may be performed in an inert atmosphere, such as for example an argon atmosphere.

In step (a), the heating may be performed at a temperature of at least about 450° C.

In step (a), the heating may be performed at a temperature between about 450° C. and about 800° C., or at a temperature between about 450° C. and about 750° C., or at a temperature between about 450° C. and about 700° C., or at a temperature between about 450° C. and about 650° C., or at a temperature between about 550° C. and about 650° C., or at a temperature of about 600° C.

In step (a), the heating may be performed for a period of time between about 2 minutes and about 2 hours, or for a period of time between about 5 minutes and about 90 minutes, or for a period of time between about 5 minutes and about 30 minutes, or for about 20 minutes.

In step (b), the mixture may be heated at a temperature of at least about 800° C.

In step (b), the mixture may be heated at a temperature between about 800° C. and about 1450° C., or at a temperature between about 1300° C. and about 1400° C., or at a temperature of about 1400° C.

In step (b) the heating may be performed for a period of time between about 2 minutes and about 2 hours, or for a period of time between about 5 minutes and about 90 minutes, or for a period of time between about 10 minutes and about 30 minutes, or for about 20 minutes, or for about 30 minutes.

Step (b) may be performed in an inert atmosphere, such as for example an argon atmosphere.

The cobalt-containing compound may be, or may comprise, LiCoO₂.

The thermal cathode product and the thermal anode product may be present in the mixture in the following ratios (w/w): between 1:1 and 8:1, or about 5:1.

The process may further comprise capturing gas produced from the heating in step (a).

The process may further comprise separating the thermal cathode product and the thermal anode product from their respective metal foils and recovering the metal foils.

The metal foils recovered may have a purity of at least about 95%.

The metal foils recovered may be free, or substantially free, of cathode active materials and/or metal oxides.

The first metal foil may be aluminium foil and the second metal foil may be copper foil.

The cobalt may be recovered in a purity of at least about 95%.

In step (a), the cathodes and anodes may be heated separately from one another.

The process may not involve subjecting the cathodes or anodes to solvents, such as for example, aqueous solutions, acidic solutions or basic solutions.

In a second aspect there is provided cobalt, whenever obtained by the process of the first aspect.

### Definitions

The following are some definitions that may be helpful in understanding the description of the present disclosure. These are intended as general definitions and should in no way limit the scope of the present disclosure to those terms alone, but are put forth for a better understanding of the following description.

Throughout this specification, unless the context requires otherwise, the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The terms “a” and “an” are used herein to refer to one or to more than one (i.e. to at least one) of the grammatical object of the article. By way of example, “an element” means one element or more than one element.

In the context of this specification the term “about” is understood to refer to a range of numbers that a person of skill in the art would consider equivalent to the recited value in the context of achieving the same function or result.

Any numerical range recited herein is intended to include all sub-ranges of the same numerical precision subsumed within the recited range. For example, a range of 1.0 to 5.0 is intended to include all sub-ranges between (and including) the recited minimum value of 1.0 and the recited maximum value of 5.0, that is, having a minimum value equal to or greater than 1.0 and a maximum value equal to or less than 5.0, such as 2.1 to 4.5. Any maximum numerical limitation recited herein is intended to include all lower numerical limitations subsumed therein and any minimum numerical limitation recited herein is intended to include all higher numerical limitations subsumed therein.

### BRIEF DESCRIPTION OF THE DRAWINGS

FIG. 1: Schematic illustration of a process in accordance with one embodiment of the disclosure in which metallic cobalt is recovered from LIBs using the anode and cathode materials. In addition, Cu and Al foil are also recovered.

FIG. 2: (a) TGA analysis of the cathode of the LIBs when heated up to 700° C.; (b) FT-IR analysis of condensed gas generated from the cathode materials following step (a).

FIG. 3: (a)-(d) are digital images of the cathode before (a) and after different heat treatment temperatures. (e)-(f) are digital images of the anode before (e) and after heat treatment at 600° C. (g) image of a recovered thermal cathode product. (h) image of a recovered thermal anode product (graphite).

FIG. 4: XRD pattern of the materials obtained from the cathode and anode of the LIBs following step (a).

FIG. 5: Characteristic XPS spectra for recovered Al and Cu foils from the cathodes and anodes of spent LIBs.

FIG. 6: X-ray diffraction patterns of recovered metal foils: (a) Al from the cathode (b) Cu from the anode.

FIG. 7: (a) TGA following the heating of a mixture of a thermal anode product and a thermal cathode product from 0 to 1000° C., (b) IR gas analysis of the off-gas from the furnace at 800. 1000, 1200 and 1400° C.

FIG. 8: X-ray diffraction pattern of the thermal anode and cathode products (powders) before and after performance of step (b).

FIG. 9: Digital image of samples obtained after step (b).

FIG. 10: XPS spectra of the recovered Co metal at 1400° C.

FIG. 11: SEM image of recovered Co metal from spent LIBs and the corresponding EPMA analysis.

### DETAILED DESCRIPTION

In one aspect of the disclosure there is provided a process for recovering cobalt from LIBs, the process comprising:
(a) heating: (i) cathodes obtained from the LIBs, the cathodes comprising a first metal foil and a cobalt-containing compound, and (ii) anodes obtained from the LIBs, the anodes comprising a second metal foil and carbon, so as to provide first and second metal foils, a thermal cathode product comprising the cobalt-containing compound, and a thermal anode product comprising the carbon; and
(b) heating a mixture of the thermal cathode product and the thermal anode product for a period of time sufficient to produce the cobalt.

The process of the disclosure utilizes two thermal-based steps in which cobalt is recovered from LIBs using the cathode and anode materials. The LIBs may be waste or spent LIBs. The cathodes of LIBs typically comprise a metal foil (which acts as a current collector) onto which is deposited an active material. Many of these active materials comprise cobalt-containing compounds, such as LiCoO₂. The active material is secured to the metal foil using a binder, such as polyvinylidene fluoride (PVF) or styrene-butadiene rubber (SBR). The anodes of LIBs typically comprise a metal foil onto which is deposited carbon, typically in the form of graphite.

In step (a), the cathodes and anodes are heated in order to facilitate disengagement of the metal foils and the materials deposited thereon. Disengagement is achieved by degradation of the binders in each electrode, which are converted to gaseous products. At the completion of step (a) one obtains first and second metal foils, a thermal cathode product and a thermal anode product. The thermal cathode product is comprised primarily of the cobalt-containing compound, and the thermal anode product is comprised primarily of carbon.

The first and second metal foils may be separated from the thermal cathode product and the thermal anode product following step (a), and recovered. In some embodiments, the metal foils may be separated from the thermal cathode and anode products by peeling the thermal cathode and anode products off of the metal foils. In some embodiments, the first and second metal foils may be recovered with a purity of at least about 95%, at least about 96%, at least about 97%, at least about 98%, or at least about 99%, or about 99%. The first and second metal foils may be recovered free, or substantially free, of active electrode materials and/or metal oxides. Typically, aluminium foil is used in the cathodes of LIBs and copper foil is used in the anodes of LIBs. However, those skilled in the art will appreciate that where alternative metal foils are used for one or both of the anode and the cathode in a given LIB, the process of the disclosure may be used to recover such alternative foils.

In some embodiments, the anodes and cathodes may be heated together in step (a). In other words, the anodes and cathodes may be mixed and then subjected to heating together. Preferably however, the cathodes and anodes are heated separately in step (a) so that the first and second metal foils, the thermal cathode product and the thermal anode product can be easily separated from one another.

In step (a), the heating may be performed at a temperature of at least about 450° C. In alternative embodiments, in step (a), the heating may be performed at a temperature between about 450° C. and about 800° C., or at a temperature between about 450° C. and about 700° C., or at a temperature between about 450° C. and about 660° C., or at a temperature between about 450° C. and about 650° C., or at a temperature between about 500° C. and about 650° C., or at a temperature between about 500° C. and about 625° C., or at a temperature between about 550° C. and about 625° C., or at a temperature between about 575° C. and about 625° C., or at a temperature of about 600° C.

In step (a), the heating may be performed for a period of time between about 2 minutes and about 2 hours, or for a period of time between about 2 minutes and about 90 minutes, or for a period of time between about 2 minutes and about 75 minutes, or for a period of time between about 5 minutes and about 2 hours, or for a period of time between about 5 minutes and about 90 minutes, or for a period of time between about 5 minutes and about 75 minutes, or for a period of time between about 2 minutes and about 60 minutes, or for a period of time between about 5 minutes and about 60 minutes, or for a period of time between about 2 minutes and about 45 minutes, or for a period of time between about 5 minutes and about 45 minutes, or for a period of time between about 5 minutes and about 30 minutes, or for a period of time between about 10 minutes and about 45 minutes, or for a period of time between about 10 minutes and about 30 minutes, or for about 20 minutes, or for about 20 to 25 minutes.

In one embodiment, in step (a), the heating may be performed at a temperature between about 450° C. and about 650° C. for a period of time between about 15 minutes and about 30 minutes. In another embodiment, in step (a), the heating may be performed at a temperature between about 550° C. and about 650° C. for a period of time between about 15 minutes and about 30 minutes. In a further embodiment, in step (a), the heating may be performed at a temperature of about 600° C. for a period of time between about 20 minutes and about 25 minutes.

In some embodiments, step (a) is performed in an inert atmosphere, such as for example a nitrogen atmosphere or an argon atmosphere.

In step (b) of the process, a mixture of the thermal cathode product and the thermal anode product is heated for a period of time sufficient to produce cobalt. In this step, carbothermal reduction of the cobalt-containing compounds (typically LiCoO₂ and CoO) to metallic cobalt is facilitated by the carbon present in the thermal anode product. The thermal cathode product and the thermal anode product may be present in the mixture in the following ratios (w/w): between about 1:1 and about 8:1, or between about 2:1 and about 7:1, or between about 3:1 and about 6:1, or between about 4:1 and about 5:1, or about 5:1. Notably, step (b) does not require an exogenous reductant to achieve the reduction. Rather, the reductant (i.e. carbon) is obtained from the LIBs, further adding to the efficiency of the process.

Following step (b), metallic cobalt may be recovered in a purity of at least about 90%, at least about 91%, at least about 92%, at least about 93%, at least about 94%, at least about 95%, or about 96%.

In one embodiment, in step (b), the mixture may be heated at a temperature of at least about 800° C. In alternative embodiments, in step (b), the mixture may be heated at a temperature between about 800° C. and about 1450° C., or at a temperature between about 800° C. and about 1400° C., or at a temperature between about 900° C. and about 1450° C., or at a temperature between about 950° C. and about 1450° C., or at a temperature between about 1000° C. and about 1450° C., or at a temperature between about 1000° C. and about 1400° C., or at a temperature between about 1000° C. and about 1425° C., or at a temperature between about 1050° C. and about 1450° C., or at a temperature between about 1100° C. and about 1450° C., or at a temperature between about 1150° C. and about 1450° C., or at a temperature between about 1200° C. and about 1450° C., or at a temperature between about 1250° C. and about 1450° C., or at a temperature between about 1300° C. and about 1450° C., or at a temperature between about 1350° C. and about 1450° C., or at a temperature between about 1375° C. and about 1425° C. or at a temperature of about 1400° C.

In step (b) the heating may be performed for a period of time between about 2 minutes and about 2 hours, or for a period of time between about 2 minutes and about 90 minutes, or for a period of time between about 2 minutes and about 75 minutes, or for a period of time between about 5 minutes and about 2 hours, or for a period of time between about 5 minutes and about 90 minutes, or for a period of time between about 5 minutes and about 75 minutes, or for a period of time between about 2 minutes and about 60 minutes, or for a period of time between about 5 minutes and about 60 minutes, or for a period of time between about 2 minutes and about 45 minutes, or for a period of time between about 5 minutes and about 45 minutes, or for a period of time between about 5 minutes and about 35 minutes, or for a period of time between about 10 minutes and about 45 minutes, or for a period of time between about 10 minutes and about 40 minutes, or for a period of time between about 15 minutes and about 40 minutes, or for a period of time between about 10 minutes and about 30 minutes, or for about 20 minutes, or for about 30 minutes.

In one embodiment, in step (b), the heating may be performed at a temperature between about 1300° C. and about 1450° C. for a period of time between about 15 minutes and about 40 minutes. In another embodiment, in step (b), the heating may be performed at a temperature between about 1350° C. and about 1450° C. for a period of time between about 15 minutes and about 35 minutes. In a further embodiment, in step (b), the heating may be performed at a temperature of about 1400° C. for a period of time between about 20 minutes and about 30 minutes.

In some embodiments, step (b) may be performed in an inert atmosphere, such as for example a nitrogen or an argon atmosphere.

In another aspect of the disclosure there is provided metallic cobalt, whenever obtained by the process of the first aspect.

### EXAMPLES

The present disclosure is further described below by reference to the following non-limiting examples.

### Recovery of Metallic Cobalt, Copper Foil and Aluminium Foil from Waste LIBs

### Materials

Lithium-ion phone batteries were retrieved from a waste-battery collection point at the University of New South Wales, Sydney, Australia. The cathode active material in these batteries was LiCoO₂. The batteries were discharged by connecting the battery anode and cathode to platinum wires and dipping the wires in a 5 wt. % NaCl solution for more than 8 hours to ensure the battery was fully drained and discharged to 0 V before disassembly in an inert atmosphere. Battery components such as cathodes, anodes, separators, metal casings and plastics were separated after disassembly. The elemental composition of the cathode active material prior to any thermal treatment is shown below in Table 1.

TABLE 1
Initial content of the cathode active material prior to thermal treatment

| | Element | | | | | | | | |
|---|---|---|---|---|---|---|---|---|---|
| | Co | Li | Al | Cr | Cu | Ni | P | Ti | Mn |
| | unit | | | | | | | | |
| | % wt | % wt | mg/kg | mg/kg | mg/kg | mg/kg | mg/kg | mg/kg | mg/kg |
| Amount | 56.01 | 6.00 | 581.64 | 4.81 | 6.97 | 155.58 | 150 | 18 | 20.38 |

### Thermal Treatments

Step (a)—Thermal Disengagement

Initially, the cathode and anode electrode foils were subjected to heat treatment in an argon atmosphere across a range of temperatures (i.e. 400-700° C.) and holding times (5-30 minutes) in a furnace. The optimum temperature was determined to be 600° C., and clean retrieval of the electrode active materials from the foils was achieved in 20 minutes. However, the binder used during electrode deposition and any residual electrolytes can be decomposed below 600° C., meaning that a lower temperature can be used if desired.

Step (b)—Thermal Transformation

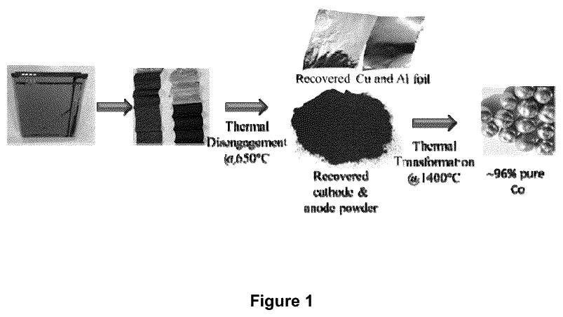

The thermal cathode product and the thermal anode product obtained following step (a) were separately ground into fine powders. A mixture comprising the powdered thermal cathode product and the powdered thermal anode product was then prepared in which the w/w ratio was 5:1. The mixture was heated for 15-60 minutes at a range of temperatures (800-1400° C.) in an inert atmosphere created in a horizontal tube furnace with an Ar flow of 0.5 L/min. The optimum temperature and time were found to be 1400° C. and 20 minutes respectively. The concentrations of CO, CO₂, and CH₄ gases generated throughout step (b) were measured using an infrared (IR) off-gas analyzer (ABB, Advanced Optima, and Easy line Series AO2000). It was observed that, after 20 minutes, no significant concentrations of CO, CO₂ and CH₄ were detected in the off-gas, meaning that heating could be stopped at that point. The off-gas was passed through ice-cold water to ensure the condensation and precipitation of valuable materials that may have been extracted in a gaseous form. FIG. 1 illustrates the thermal steps used in the process.

### Material Characterisation

### General Methods

The aluminium, copper, lithium and cobalt metals recovered from the LIBs were characterised by a PerkinElmer OPTIMA 7300 coupled with inductive plasma-optical emission spectroscopy (ICP-OES). In each case, 0.5 g of the metal sample was digested in a mixture of 30% HCl and 70% HNO₃ followed by open digestion. After the ICP-MS, all the samples were analyzed by ICP-OES. Thermogravimetric analysis (TGA) was performed using a PerkinElmer simultaneous thermal analyzer STA-8000 at a heating rate of 20° C. min⁻¹. Condensed gas products collected in a liquid form by the cold trap during step (a) were investigated using a Fourier transform infrared spectrometer (FT-IR). PANalytical Empyrean II XRD system with Bragg-BrentanoHD (BBHD) geometry, and Co Kα radiation (λ=1.789 Å) was used to collect X-ray diffraction (XRD) data in the 10°≤2θ≤120° range. The collected data was processed using HighScore Plus software. Scientific ESCALAB250Xi was used by the X-ray photoelectron spectrometer to carry out XPS on the initial samples and final metallic products. The source of X-rays was monochromated Al Kα (energy 1486.68 eV). The analysis was performed at a photoelectron take-off angle of 90° under ultra-high vacuum (˜2×10⁻⁹ mbar). The adventitious carbon C 1 s peak at 284.8 eV was used for referencing the binding energy. To reveal the quantitative elemental mapping precisely, electron probe microanalysis (EPMA) was used. The EPMA machine was JEOL JXA-8500F which was operated for the WDS mapping. EPMA was used to detect the exact elemental composition of the cobalt metal. The experiment was performed on a polished surface, with beam energy of 15 kV and current of 40 nA. The same analytical conditions were applied to perform the mapping on secondary standards for quality control. The recycling efficiencies for cobalt from spent LIBs were calculated in percentage form according to the following formula:

$$Recovery rate = \frac{weight of Co in the recovered metal}{total weight of Co in the initial cathode powder} \times 100$$

### Thermal Cathode and Anode Products

In LIB manufacturing SBR or PVF are generally used as organic binders which help to create a coating of the cathode active material on the Al foil. During the charge-discharge process of battery operation, the cathode coating disengages from the Al foil over time. Further, when heat is applied the binder and any residual organic electrolytes degrade into gases leaving behind metal oxides on the foil. These off-gases could be transferred to gas collectors or off-gas burners where they can be reprocessed for use in other applications. The main benefit of this heat-mediated disengagement technique is that the cathodes of the LIBs are easily separated from the metallic foil as a result of degradation of the binder.

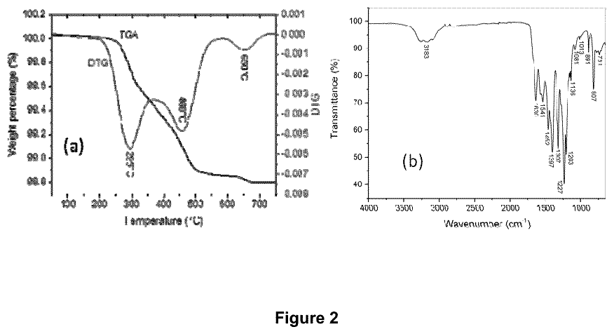

TGA analysis of the cathodes including Al foil is represented in FIG. 2a, where peaks in the derivative (DTG) signify the temperatures where degradations occur. Overall weight loss during the TGA represents the volatiles present in the cathode active materials after dismantling. The material contains mainly PVF and phenoxy resin (PR) in the thin metallic layer. Three significant degradation peaks are attributed to the combined degradation characteristics of PVF and PR, where the first two degradation peaks at 295° C. and 460° C. may be due to the degradation of PVF, and the third peak at 650° C. is a result of the degradation behaviour of the binder. The electrolyte in the LIBs is LiPF₆, which is reported as having thermal stability up to 380° C. The major degradation observed from the TGA analysis was from 250° C. to 500° C. It is obvious that the binder along with the electrolyte material degrade in this temperature zone. It is predicted that PVF decomposed at the beginning, and when the temperature was increased, LiPF₆ decomposed and produced LiF as a solid and PF₅ as a gaseous product. The solid LiF reacts with the carbon of the PVF and is released as a fluoro compound which is evident in the FTIR spectra.

The TGA data reveals that 650° C. is the ideal temperature for step (a), and an optimum time of 15 minutes was established after a series of experiments. However, using a temperature of 600° C. and a time of 20 to 25 minutes provided a similar result and is preferable in order to avoid any partial melting of aluminium (which has a melting point of ˜660° C.).

During step (a) the generated gases were condensed and collected in liquid form from the condenser, and their composition analyzed using FT-IR. As shown in FIG. 2b, broad and weak peaks with the peak range of 3300 to 3000 cm⁻¹ were ascribed as O—H bonding for the intramolecular bonded components. The strong peak at 1630 cm⁻¹ is present due to the stretching vibration of C═C bonding. The peaks between 1400 and 1000 cm⁻¹ are for fluoro compounds and ascribed to C—F bonding. The peaks between 830 and 890 cm⁻¹ were due to C—H out-of-plane deformation vibration and P—F stretching vibration. The peaks 731 to 735 cm⁻¹ were due to in-plane stretching vibration and P—F stretching vibration. The detailed band assignment is outlined in Table 2 below. The FT-IR analysis showed that the condensed and recovered product from step (a) is rich in fluoro compounds, which proves that the process of the disclosure can prevent environmental pollution. Further processing of these fluorocarbons can enable the repurposing of the condensed materials.

TABLE 2
Band assignment for the spectrum of the condensed
product obtained following step (a)

| Peak range (cm⁻¹) | Assignment |
|---|---|
| 3183 | O—H, stretching vibration, alcohol |
| 1804, 1775 | C═O, stretching vibration, H₂C═CF-R groups |
| 1644 | C═O, stretching vibration, carbonyl |
| 1397, 1307, 1227, | C—F, stretching vibration, fluoro compounds |
| 1203, 1136, 1013 | |
| 890, 830 | C—H, out-of-plane bending vibration, vinylidene |
| | groups/P—F stretching vibration |
| 731, 735 | C—F, in-plane bending vibration, general range, P—F |
| | stretching vibration |

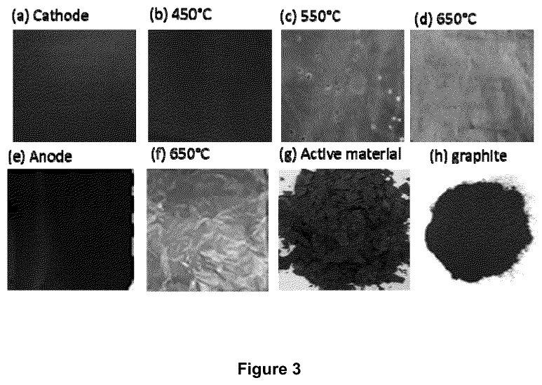

The effect of heating in step (a) was investigated in the range from 400° C. to 700° C. To understand the effect of temperature, images were captured of the foils at different temperatures and also the recovered thermal cathode and anode products. The results are shown in FIG. 3 (note that heating was performed for 20 minutes). It is apparent from FIG. 3 that the cathode active material did not substantially change until about 450° C. At temperatures above about 450° C. the cathode active material starts to disengage from the Al foil. However, the optimum disengagement temperature was found to be about 600° C., at which stage the peeling of the active materials from the foil was smooth (see FIGS. 3d and 3f). Beyond this temperature, and for time periods beyond about 20 minutes, the Al foil become susceptible to oxidation. In contrast, the recovered Al foil at 600° C. was found to be highly pure and intact such that it could be repurposed again for various applications.

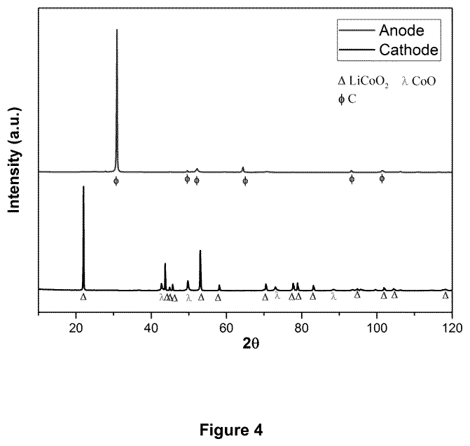

The XRD of the cathode active material is shown in FIG. 4. The XRD peaks identified phases of LiCoO₂ and CoO. The CoO is likely formed during step (a) via decomposition of LiCoO₂. The black powder recovered from the anode active material was identified as pure graphite.

### Recovered Metal Foils

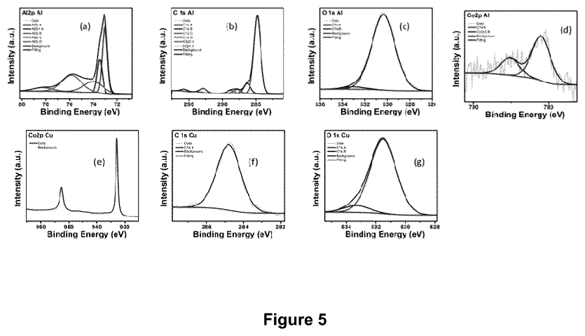

The quality of the surface of the Al and Cu foil recovered after step (a) was investigated by X-ray photoelectron spectroscopy (XPS), and the elemental composition of the metal foils was measured by ICP-OES analysis. FIG. 5 shows the XPS spectra of the major components detected on the surface of the recovered Al and Cu, and other minor trace elemental spectra. Table 3 summarizes the possible compounds detected by XPS on the metallic surfaces with regard to the corresponding binding energy and photoelectron lines.

TABLE 3
Elemental compositions on the metallic surfaces
of the recycled Cu, and Al estimated by XPS.

| | | Binding | Photo- | | |
|---|---|---|---|---|---|
| | Ele- | Energy | electron | | Atomic |
| Metal | ment | (eV) | line | Possible compounds | % |
| Alumin- | C | 284.8 | 1s | Carbon | 17.27 |
| ium | C | 286.4 | 1s | C—N, C—O in | 0.71 |
| | | | | alcohols/ether, and C—F | |
| | O | 530.35 | O1s | Al₂O₃, CoO | 15.7 |
| | O | 532.99 | O1s | Al₂O₃ | 1.01 |
| | Al | 73.04 | 2p3 | Aluminium | 33.33 |
| | Al | 74 | 2p | Al₂O₃ | 8.52 |
| | Al | 75.83 | 2p | Al/Al₂O₃ | 15.04 |
| | Al | 78.26 | 2p | Al/Al₂O₃ | 2.45 |
| | Co | 778.96 | 2p3 | CoO | 0.61 |
| | Co | 781.3 | 2p3 | Co²⁺ satellite for CoO | 0.29 |
| | Co | 783.59 | 2p3 | CoO | 0.19 |
| | Co | 787.27 | 2p3 | Co²⁺ satellite for CoO | 0.12 |
| Copper | Cu | 932.8 | 2p3 | Cu | 89.25 |
| | O | 530.53 | 1s | CuCO₃ | 0.93 |
| | O | 531.53 | 1s | CuCO₃ | 0.13 |
| | C | 284.8 | 1s | Carbon | 11.38 |

Although aluminium is prone to oxidation under any conditions, the detected oxidation of the recovered Al foils (FIG. 5(c)) is comparatively lower in concentration at ˜16.08%—as identified from the spectra for aluminium 74, 75.83 and 78.25 eV (FIG. 5a), and oxygen at 530.35 eV and 532.99 eV (FIG. 5C). The atomic percentage of residual carbon is ˜17.98%—identified from the spectra at 284.5 eV and 286.4 eV (FIG. 5b). The spectra of cobalt oxides were detected at 778.96 eV, 781.3 eV, 283.59 eV, and 787.27 eV (FIG. 5d), and result from the residual cathode material. The Al foil appears to act as a catalyst for LiCoO₂ at elevated temperature, and during step (a) a small amount of cathode material reacted with the Al foil and produced CoO (see Equation 1 below). This is also no doubt the reason for the small amount of Al₂O₃ present on the Al surface. However, the binder decomposed to form a uniform graphitic carbon layer on the surface of the Al foil, which kept the aluminium free from abrupt oxidation.

6LiCoO₂+2Al=3Li₂O+Al₂O₃+6CoO (1)

XPS analysis confirmed that there is no evidence of oxidation on the surface of the Cu foils obtained after step (a). The recovered copper shows a characteristic peak at 932.8 eV, which is attributed to pure copper metal. Generally, satellite peaks due to oxidation in the copper are noticeable in the range of 945-943 eV, however these peaks are completely absent (FIG. 5e). Another peak of pure copper is observed at 952.5 eV, and is attributed to the spin-orbit splitting of the copper 2p orbitals. The amount of oxygen present on the copper's surface is very small, and is not bonded to the carbon. The residual carbon detected on the Cu surface is ˜11% (Table 3), and is free carbon resulting from the residual anode materials of the battery and the degradation of the binders (FIG. 5f). Oxygen molecules are identified in the XPS spectra, with two peaks at 530.53 eV and 531.53 eV with a chemical shift of ˜1 eV (FIG. 5g) which may be attributed to the presence of CuCO₃.

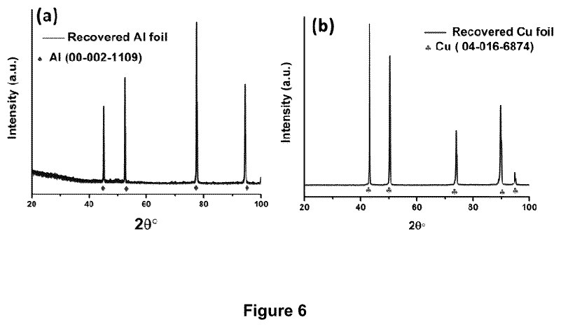

The phase information and composition of the metal foils were also characterised by X-ray diffraction (XRD) as shown in FIG. 6. FIG. 6a represents the XRD patterns of the Al foil recovered from the cathodes after step (a). XRD patterns in the range of 20-100° are characterised as aluminium (Al FCC peaks at 40.6°, 45.2°, 47.3°, 52.5°, 77.6°, and 94.5°). The Cu foil recovered from the anodes also shows peaks for pure FCC Cu at 43.1°, 50.3°, 73.9°, 89.7°, and 94.1° (FIG. 6b). No other components were detected in the XRD pattern, implying that no other component had a concentration of more than 3%.

The elemental composition of the recovered Cu and Al was measured using laser-induced breakdown spectroscopy, represented in Table 4. The purity of the recovered Cu and Al was ˜98.5% with some minor trace elements which could have existed in the basic composition of the foils or been derived from polymers or interfaces between polymers and metals.

TABLE 4
Elemental composition of the recovered metals
in weight percentage after step (a)

| Metal | | | | | | | | | |
|---|---|---|---|---|---|---|---|---|---|
| foils | Al | Co | Cu | Fe | Mn | Ni | Pb | Si | Sn |
| Cu | 0.06 | — | 99.09 | 0.04 | 0.10 | 0.02 | 0.01 | 0.43 | 0.01 |
| Al | 98.89 | 0.80 | 0.02 | 0.10 | 0.02 | 0.06 | 0.01 | 0.03 | 0.00 |

### Thermal Transformation of the Cathode and Anode Products

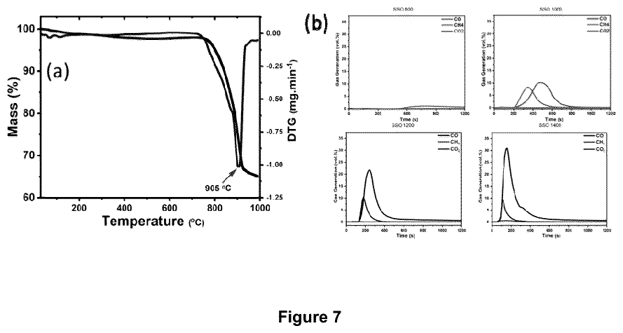

TGA of the 5:1 (w/w) mixture of the thermal cathode product/thermal anode product (referred to below as “SSO”) was performed up to 1000° C. at a 20° C./min heating rate under an inert atmosphere created by nitrogen gas purging at a flow rate of 20 ml/min. TGA results are shown in FIG. 7a. The TGA of mixed metal graphite compounds was performed to demonstrate the loss of volatile material from 0 to 1000° C. upon reaching ˜35% metal loss. Substantial weight loss occurs during the heat treatment process, which could be the result of compounds having a low boiling point. It is noted that the mass loss began at 800° C., and there was a steep decrease in mass at around 905° C. This significant reduction in weight occurs due to the liberation of lithium compounds that become volatile at this increased temperature along with the CO and CO₂ gases. It is also apparent from the XRD spectra that the reaction between LiCoO₂ and graphite starts above 800° C., where the CO and the CO₂ are released.

An infrared gas analyzer was used to detect the release of CO and CO₂ gases at various temperatures, as presented in FIG. 7b. It was observed that there was variation in the amount of gas generation in the temperature range 800-1400° C. At 800° C., the generation of CO and CO₂ was not significant. Very small amounts of these gases were detected, which can be attributed to decomposition of LiCoO₂. When the temperature was increased further, the concentration of these gases increased. At 1000° C., the concentration of the gases peaked less than 10 minutes into the reaction. This phenomenon denotes the fast breakdown of lithium compounds in the cathode material (LiCoO₂). In the first stage of decomposition, LiCoO₂ produces Li₂O and CoO. In the next stage, the generated CO₂ reacts with Li₂O and produces Li₂CO₃. This reaction is observed when the CO₂ concentration is less than the concentration of CO. It is observed that at up to 1000° C., the concentration of CO in the off-gases is greater than that of CO₂. At more elevated temperatures, the CO₂ concentration is lower, and this reduction in the concentration of the CO₂ was significant when the temperature was 1400° C. During high-temperature transformation, evolved CO₂ reacts with Li₂O to form Li₂CO₃. This process also involves the carbothermal reduction reaction of CoO to metallic cobalt.

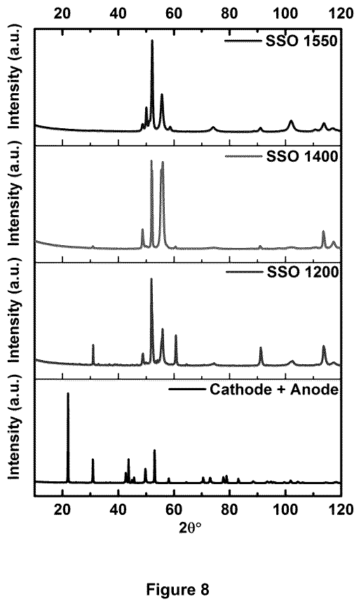

To obtain the optimal thermal transformation parameters for step (b), a series of heat treatment times and temperatures were investigated. The effect of temperature on Co recovery was observed in the range 800-1400° C., and the most efficient temperature was found to be 1400° C. At this temperature, all the significant peaks in the XRD spectra were found to originate from Co. The X-ray diffraction spectra of the mixture of the thermal cathode product/thermal anode product at various temperatures is shown in FIG. 8. The initial materials show strong peaks of LiCoO₂ with a small amount of CoO (Equation 1).

Thermal transformation at 1400° C. creates complete dissociation of LiCoO₂, with a carbothermal reduction reaction producing bulk metallic cobalt and a small amount of carbides (less than 3%), which are detected in the XRD patterns. At 1400° C., LiCoO₂ reacts with carbon to produce Li₂O, CoO/Co₃O₄, and CO₂. This evolved CO₂ reacts again with Li₂O to produce Li₂CO₃, which corresponds with the TGA and IR gas analyses. At 1400° C., Li₂CO₃ is unstable and goes into the gas phase. The CoO reacts with solid carbon and produces metallic Co, as evident in FIG. 8. The excess carbon assisted in the formation of ‘clean’ metallic Co, and there was no CoO left in the system at this temperature. The above can be described by the following equations:

C+12LiCoO₂→6Li₂O+4Co₃O₄+CO₂ (2)

C+4LiCoO₂→2Li₂O+4CoO+CO₂ (3)

2Co₃O₄+C→6CoO+CO₂ (4)

Li₂O+CO₂→Li₂CO₃ (5)

2CoO+C→2Co+CO₂ (6)

The optimum carbothermal reduction conditions were selected as 1400° C. for 30 minutes, as these conditions are adequate for the dissolution of LiCoO₂ into Li₂CO₃, followed by complete evaporation of Li₂CO₃—leaving only pure metallic cobalt and carbon residue.

### Compositional Analysis of Recovered Cobalt

After carbothermal reduction, the composition of the metallic product was assessed using ICP-OES analysis for three samples at each temperature. After heat treatment, SSO 800 and SSO 1000 were found to be in a powder form, whereas SSO 1200 and SSO 1400 were in bulk metallic form with carbon residuals. Elemental compositions for the samples are summarized in Table 5 below.

As the temperature increased, a greater percentage of metallic components was detected, which indicated that undetectable components (such as C, O, N, and H) were gradually decreasing. This phenomenon was observed for all detected elements, where the percentage of weight increased with increasing temperature. However, in the case of lithium, the weight percentage decreased with increasing temperature, as shown in Table 5. This could be related to the previous XRD data, and is attributed to the elimination of lithium in gaseous form throughout the reactions (e.g. Li₂CO₃).

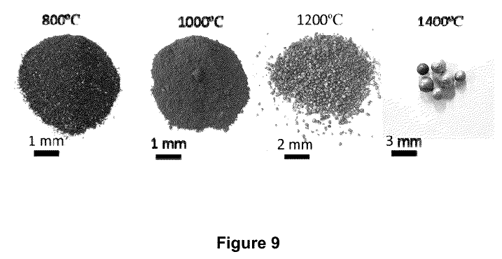

When comparing the raw and SSO 800 samples, the sum of the weight percentages of metals increases by only ˜6%, which indicates that there was a large amount of carbon present even after heat treatment at 800° C. For SSO 1000, the amount of lithium decreased to ˜2%, which possibly indicates a minor formation of Li₂CO₃, and eliminates from the powder at elevated temperatures. This reaction is further accelerated at 1400° C., with a loss of all lithium components, (6% in SSO raw to 0% in SSO 1400). Digital images of the Co samples after the heat treatment are provided in FIG. 9.

TABLE 5
ICP-OES of the recovered Co at different temperatures

| | | | | | | | | | | | The recovery |
|---|---|---|---|---|---|---|---|---|---|---|---|
| | | | | | | | | | | | rate for Co |
| ID | Co | Li | Al | Cu | Fe | Mn | Ni | P | Ti | C | (%) |
| SSO | 56.01 | 6.00 | 0.27 | 0 | 0.02 | 0.01 | 0.03 | 0.01 | 0.01 | | — |
| raw (only | | | | | | | | | | | |
| cathode) | | | | | | | | | | | |
| SSO800 | 60.03 | 5.69 | 0.27 | 0 | 0.02 | 0.01 | 0.03 | 0.01 | 0.01 | 30.01 | — |
| SSO1000 | 61.09 | 1.90 | 0.27 | 0 | 0.02 | 0.01 | 0.03 | 0.01 | 0.01 | 25.43 | — |
| SSO1200 | 65.47 | .89 | 0.27 | 0.01 | 0.01 | 0.01 | 0.02 | 0.16 | 0.26 | 9.83 | 86 |
| SSO1400 | 95.78 | 0 | 0.2 | 0.03 | 0.02 | 0.01 | 0.03 | 0.1 | 0.01 | 0.43 | 97 |

The exact composition of the recovered cobalt droplet at 1400° C. has been analyzed by both laser-induced breakdown spectroscopy and inductively coupled plasma mass spectroscopy (ICP-MS) techniques. The results are shown in Table 6. In both the cases, the purity of the cobalt was ˜96%.

TABLE 6
Composition of the recovered cobalt at 1400° C.

| Elements | Co | Li | Al | Cu | Fe | Mn | Ni | P | Ti |
|---|---|---|---|---|---|---|---|---|---|
| Weight % | 96.1 | 0 | 0.2 | 0.03 | 0.02 | 0.01 | 0.03 | 0.1 | 0.01 |
| by ICP | | | | | | | | | |
| Weight % | 96.5 | 0 | 0.05 | 0.01 | 0.01 | 0.01 | 0.01 | 0.04 | 0.01 |
| by LIBS | | | | | | | | | |

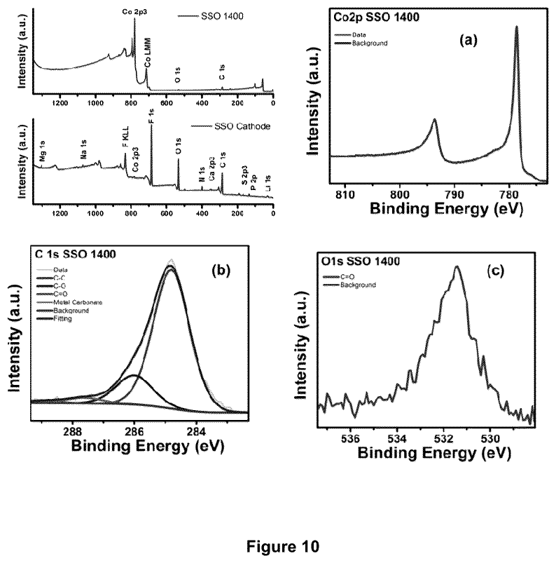

The cobalt metal obtained at 1400° C. was studied using XPS analysis to determine the chemical state of the metallic cobalt (FIG. 10). XPS revealed a characteristic cobalt asymmetric peak at 778.2 eV, which was attributed to the presence of pure cobalt metal. The XPS spectrum revealed that there were no cobalt oxide peaks, which confirmed that the metal was free from oxidation. The carbon peak at 287.6 eV was bonded with cobalt in Co₃C or CoCO₃. The rest of the carbon peaks were due to free carbon on the surface of the metal after heat treatment. The oxygen peak at 531.5 eV was attributed to C═O or CoCO₃. The detailed atomic percentage of the elements captured by XPS are provided in Table 7. XRD analysis and XPS analysis revealed the presence of carbide. The quantification is crucial when the wt. % of any element is less than 3% by the XRD analysis (FIG. 8). XPS analysis revealed that there could be ˜3% (atomic percentage) of metal carbonate and/or carbide compounds present in the recovered Co while XRD analysis revealed that there are less than 3% (wt. %) of carbide present in the recovered Co. XRD quantification was done by the rietveld refinement technique (FIG. 8).

TABLE 7
Elemental compositions on the metallic
surfaces of Co estimated by the XPS

| | Binding | Photo- | | |
|---|---|---|---|---|
| | Energy | electron | | Atomic |
| Element | (eV) | line | Possible compounds | % |
| Co | 778.2 | 2p3 | Co metal | 81.51 |
| C | 284.8 | 1s | Carbon | 20.64 |
| C | 286 | 1s | C—O | 4.36 |
| C | 289 | 1s | carbonate | 0.36 |
| C | 287.63 | 1s | metal carbonate/carbide, C—O | 0.85 |
| O | 531.33 | 1s | CoCO₃ or C═O | 2.28 |

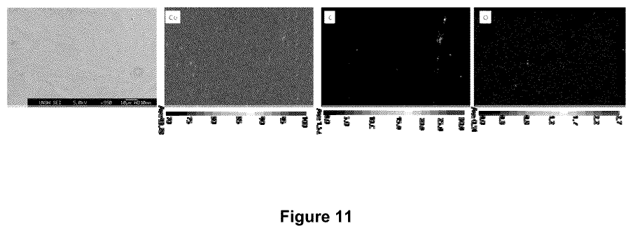

Detailed EPMA-WDS observation was performed on the recovered cobalt after heat treatment of the SSO at 1400° C. FIG. 11 demonstrates that the cobalt was distributed homogeneously, with a very small amount of carbon in a certain area. A miniscule carbon-rich region was revealed, which could be associated with the cobalt carbonate particles confirmed by the XRD analysis. Oxygen mapping revealed no traces of CoO, confirming the superior quality of the recovered cobalt metal.

The present disclosure demonstrates that metallic cobalt can be isolated from spent LIBs using two thermal steps, the first step being a thermal disengagement, the second step being a thermal transformation involving a carbothermal reduction. The process offers significant advantages over hydrometallurgical processes in that it does not require any strong acid-based or organic solutions which generate secondary waste. The facile nature of the process offers a further advantage, in that it permits Al and Cu foils from the electrodes of the LIBs to be recovered in very high purity without smelting. In addition, the condensed off-gas product resulting from the thermal disengagement step was rich in organic fluorocarbon compounds which may be easily captured in order to prevent environmental pollution.

There is growing demand for cobalt to manufacture batteries for automobiles. In the coming years, it is anticipated that this demand will rise dramatically due to the move towards new technologies for hybrid-electric vehicles. Other emerging sectors, such as turbine engines and catalysts, will also increasingly require materials including cobalt. This is projected to lead to even greater demand and consumption, placing pressure on limited natural cobalt deposits. The process of the present disclosure provides a clean, facile, efficient and sustainable alternative for recovering cobalt from LIBs that can contribute significantly to meeting the ever increasing demand for this valuable metal.

Those skilled in the art will appreciate that the disclosure described herein is susceptible to variations and modifications other than those specifically described. It is to be understood that the disclosure includes all such variations and modifications. The disclosure also includes all of the steps, features, compositions and compounds referred to or indicated in this specification, individually or collectively, and any and all combinations of an two or more of said steps, features, compositions and compounds.

1. A process for recovering cobalt from LIBs, the process comprising:
(a) heating: (i) cathodes obtained from the LIBs, the cathodes comprising a first metal foil and a cobalt-containing compound, and (ii) anodes obtained from the LIBs, the anodes comprising a second metal foil and carbon, so as to provide first and second metal foils, a thermal cathode product comprising the cobalt-containing compound, and a thermal anode product comprising the carbon; and
(b) heating a mixture of the thermal cathode product and the thermal anode product for a period of time sufficient to produce the cobalt.

2. The process of claim 1, wherein the LIBs are waste or spent LIBs.

3. The process of claim 1, wherein the carbon is graphite.

4. The process of claim 1, wherein step (a) is performed in an inert atmosphere.

5. The process of claim 1, wherein in step (a), the heating is performed at a temperature of at least about 450° C.

6. The process of claim 1, wherein in step (a), the heating is performed at a temperature between about 450° C. and about 800° C., or at a temperature between about 450° C. and about 750° C., or at a temperature between about 450° C. and about 700° C., or at a temperature between about 450° C. and about 650° C., or at a temperature between about 550° C. and about 650° C., or at a temperature of about 600° C.

7. The process of claim 1, wherein in step (a), the heating is performed for a period of time between about 2 minutes and about 2 hours, or for a period of time between about 5 minutes and about 90 minutes, or for a period of time between about 5 minutes and about 30 minutes, or for a period of time between about 20 minutes and about 30 minutes, or for about 20 minutes.

8. The process of claim 1, wherein in step (b), the mixture is heated at a temperature of at least about 800° C.

9. The process of claim 1, wherein in step (b), the mixture is heated at a temperature between about 800° C. and about 1450° C., or at a temperature between about 1300° C. and about 1400° C., or at a temperature of about 1400° C.

10. The process of claim 1, wherein in step (b) the heating may be performed for a period of time between about 2 minutes and about 2 hours, or for a period of time between about 5 minutes and about 90 minutes, or for a period of time between about 10 minutes and about 30 minutes, or for about 20 minutes, or for about 30 minutes.

11. The process of claim 1, wherein step (b) is performed in an inert atmosphere.

12. The process of claim 1, wherein the cobalt-containing compound is, or comprises, LiCoO₂.

13. The process of claim 1, wherein the thermal cathode product and the thermal anode product are present in the mixture in the following ratios (w/w): between 1:1 and 8:1, or about 5:1.

14. The process of claim 1, further comprising capturing gas produced from the heating in step (a).

15. The process of claim 1, further comprising separating the thermal cathode product from the first metal foil and separating the thermal anode product from the second metal foil, and recovering the first and second metal foils.

16. The process of claim 15, wherein the first metal foil and the second metal foil recovered have a purity of at least about 95%.

17. The process of claim 15, wherein the first metal foil and the second metal foil recovered are free, or substantially free, of cathode active materials and/or metal oxides.

18. The process of claim 1, wherein the first metal foil is aluminium foil and the second metal foil is copper foil.

19. The process of claim 1, wherein the cobalt is recovered in a purity of at least about 95%.

20. The process of claim 1, wherein in step (a), the cathodes and anodes are heated separately from one another.

21. The process of claim 1, wherein the process does not involve subjecting the cathodes or anodes to solvents.

22. The process of claim 21, wherein the solvents are aqueous solutions, acidic solutions or basic solutions.

23. (canceled)
